(19) United States
(12) Patent Application Publication
(10) Pub. No.: US 2024/0014700 A1
(43) Pub. Date: Jan. 11, 2024

(54) ROTARY ELECTRIC MACHINE

(71) Applicant: NIDEC CORPORATION, Kyoto (JP)

(72) Inventors: Yukie YAMADA, Kyoto (JP); Tomoya UEDA, Kyoto (JP)

(21) Appl. No.: 18/254,603

(22) PCT Filed: Sep. 28, 2021
(86) PCT No.: PCT/JP2021/035642

§ 371 Date: May 26, 2023

(30) Foreign Application Priority Data
Dec. 9, 2020 (JP) 2020-204251

(51) Int. Cl. H02K 1/2753

(52) U.S. Cl. CPC H02K 1/2753

(57) ABSTRACT

A rotor includes a rotor core having a hole, and a magnet inside the hole. A stator includes a stator core having an annular core back surrounding the rotor core and teeth extending inward from the core back and arranged at intervals in a circumferential direction, and coils attached to the stator core. The hole has an arc shape protruding inward. The magnet is in the hole and has an arc shape extending along the hole. The rotor core has cavity portions sandwiching the magnet. A curved outer surface of the hole is in close contact with a curved outer surface of the magnet at a portion closer to a center in the circumferential direction than an end portion in the circumferential direction. At least a part of the cavity portion extends to the outer side in the circumferential direction with respect to the center of a pole.

### CROSS-REFERENCE TO RELATED APPLICATIONS

This is the U.S. national stage of application No. PCT/JP2021/035642, filed on Sep. 28, 2021, and priority under 35 U.S.C. § 119(a) and 35 U.S.C. § 365(b) is claimed from Japanese Patent Application No. 2020-204251, filed on Dec. 9, 2020.

### FIELD OF THE INVENTION

The present invention relates to a rotary electric machine.

### BACKGROUND

A rotary electric machine that includes a rotor core and a permanent magnet arranged in a hole provided in the rotor core is known. For example, a rotary electric machine in which three permanent magnets are arranged in a ∇ shape is conventionally known.

A rotor structure of the rotary electric machine described above employs a configuration in which three permanent magnets are arranged in a ∇ shape from the viewpoint of a motor characteristic, but there is a problem that magnet cost is large because three permanent magnets are required per pole in one motor, and each permanent magnet requires magnets corresponding to the number of stages.

For example, a permanent magnet curved in a protruding shape toward the inner side in a radial direction is conventionally known. In the permanent magnet, a motor characteristic is maintained by one permanent magnet. For example, a rotary electric machine in which a permanent magnet curved in a protruding shape is divided in a circumferential direction, and a rib is provided in a rotor core between the divided permanent magnets to improve strength of the rotor core is conventionally known.

In the conventional rotary electric machines, in a case where a flux barrier having a shape obtained by extending an accommodation hole of the permanent magnet having an arc shape is provided on the outer side in a radial direction of the permanent magnet, an area receiving stress during rotation of a rotor core is small, and a load on the rotor core is large. In the conventional rotary electric machine, stress at the time of rotation of the rotor core is dispersed, and a load on the rotor core is reduced, but since a permanent magnet is divided, an output characteristic is small.

### SUMMARY

One aspect of an exemplary rotary electric machine of the present invention includes a rotor rotatable around a center axis, and a stator located on an outer side in a radial direction of the rotor. The rotor includes a rotor core having an accommodation hole, and a magnet accommodated inside the accommodation hole, the stator includes a stator core having an annular core back surrounding the rotor core and a plurality of teeth extending from the core back to an inner side in a radial direction and arranged side by side at intervals in a circumferential direction, and a plurality of coils attached to the stator core, the accommodation hole is curved in an arc shape protruding to an inner side in the radial direction when viewed in an axial direction, and has a first curved surface located on an inner side in the radial direction and a second curved surface located on an outer side in the radial direction, the magnet is provided in the accommodation hole and is curved in an arc shape extending along the accommodation hole as viewed in the axial direction, and has a third curved surface located on an inner side in the radial direction and a fourth curved surface located on an outer side in the radial direction, the rotor core has a pair of cavity portions arranged with the magnet interposed therebetween when viewed in the axial direction, the second curved surface is in close contact with the fourth curved surface at a portion closer to a center side in the circumferential direction than at least an end potion in the circumferential direction, and at least a part of the cavity portion extends to an outer side in the circumferential direction with respect to a center of a pole.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a rotary electric machine according to the present embodiment;

FIG. 2 is a cross-sectional view that is taken along a line II-II in FIG. 1 and illustrates a part of the rotary electric machine according to the present embodiment;

FIG. 3 is a cross-sectional view illustrating a part of a magnetic pole portion and a stator core of a rotor according to the present embodiment;

FIG. 4 is an enlarged diagram of a periphery of an end portion on a first side in a circumferential direction of a magnet 41 and an accommodation hole 30;

FIG. 5 is a diagram illustrating a relationship between a rotational speed of a rotor 10 and von Mises stress; and

FIG. 6 is a diagram illustrating a relationship between a current lead angle and torque.

### DETAILED DESCRIPTION

A rotary electric machine according to an embodiment of the present invention will be described below with reference to the drawings. The scope of the present invention is not limited to the embodiment described below, and can be optionally changed within the scope of the technical idea of the present invention. Further, there is a case where scales, numbers, and the like of structures illustrated in drawings below may differ from those of actual structures, for the sake of easier understanding of the structures.

A Z-axis direction appropriately illustrated in each drawing is a vertical direction in which the positive side is the “upper side” and the negative side is the “lower side”. A center axis J appropriately illustrated in each drawing is an imaginary line that is parallel to the Z-axis direction and extends in the vertical direction. In description below, an axial direction of the center axis J, that is, a direction parallel to the vertical direction is simply referred to as “axial direction”. A radial direction around the center axis J is simply referred to as “radial direction”. A circumferential direction around the center axis J is simply referred to as “circumferential direction”. An arrow θ appropriately illustrated in each drawing indicates the circumferential direction. The arrow θ is directed in a clockwise direction around the center axis J when viewed from the upper side. In description below, the side to which the arrow θ is directed in the circumferential direction with a given object as a reference, that is, the clockwise side as viewed from the upper side is referred to as “first side in the circumferential direction”, and the side opposite to the side to which the arrow θ is directed in the circumferential direction with the given object as the reference, that is, the counterclockwise side as viewed from the upper side is referred to as “second side in the circumferential direction”.

Note that the vertical direction, the upper side, and the lower side are names for simply describing an arrangement relationship of each part and the like, and an actual arrangement relationship and the like may be also an arrangement relationship and the like other than the arrangement relationship and the like indicated by these names.

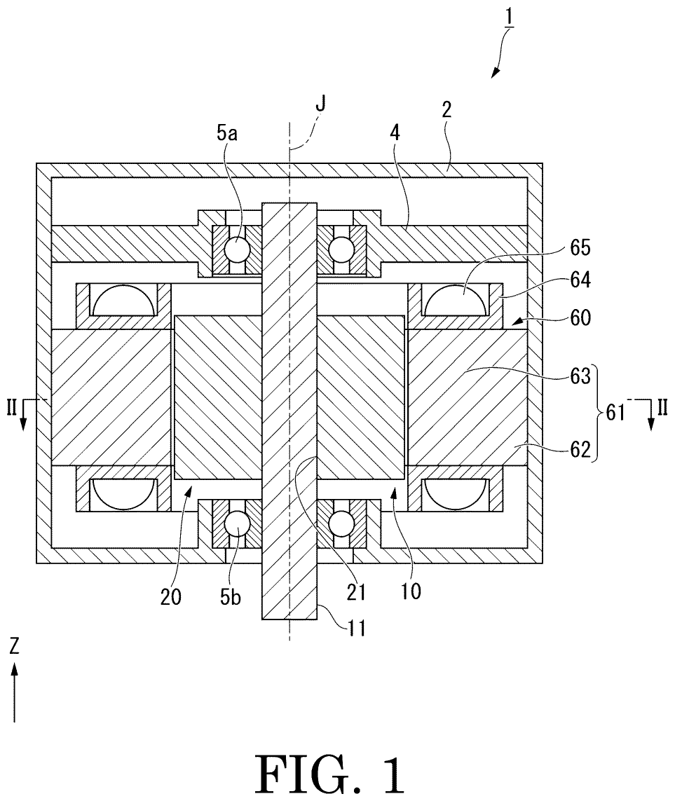

As illustrated in FIG. 1, a rotary electric machine 1 according to the present embodiment is an inner rotor type rotary electric machine.

In the present embodiment, the rotary electric machine 1 is a three-phase alternate-current rotary electric machine. The rotary electric machine 1 is, for example, a three-phase motor driven by being supplied with three-phase AC power. The rotary electric machine 1 includes a housing 2, a rotor 10, a stator 60, a bearing holder 4, and bearings 5a and 5b.

The housing 2 accommodates the rotor 10, the stator 60, the bearing holder 4, and the bearings 5a and 5b in the inside. A bottom portion of the housing 2 holds the bearing 5b. The bearing holder 4 holds the bearing 5a. For example, the bearings 5a and 5b are a ball bearing.

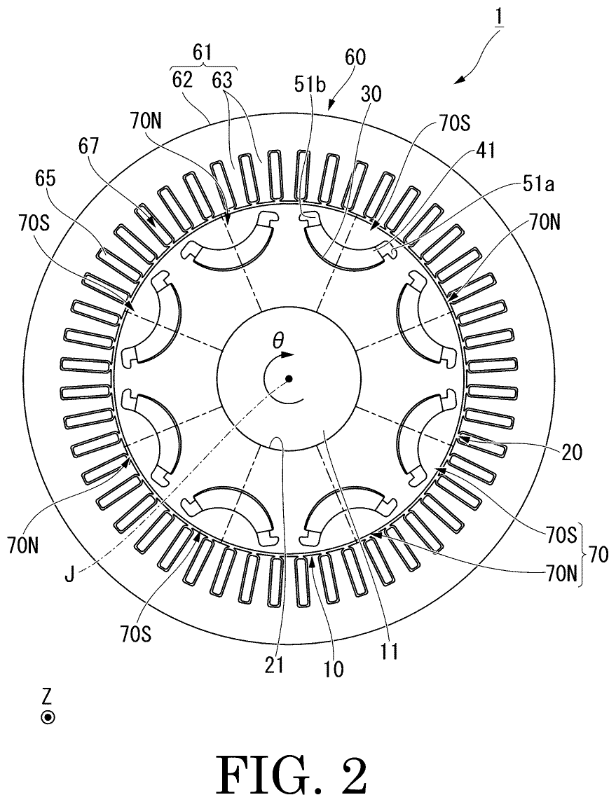

The stator 60 is positioned outside in the radial direction of the rotor 10. The stator 60 includes a stator core 61, an insulator 64, and a plurality of coils 65. The stator core 61 includes a core back 62 and a plurality of teeth 63. The core back 62 is located outside in the radial direction of a rotor core 20 to be described later. As illustrated in FIG. 2, the core back 62 has an annular shape surrounding the rotor core 20. The core back 62 has, for example, an annular shape around the center axis J.

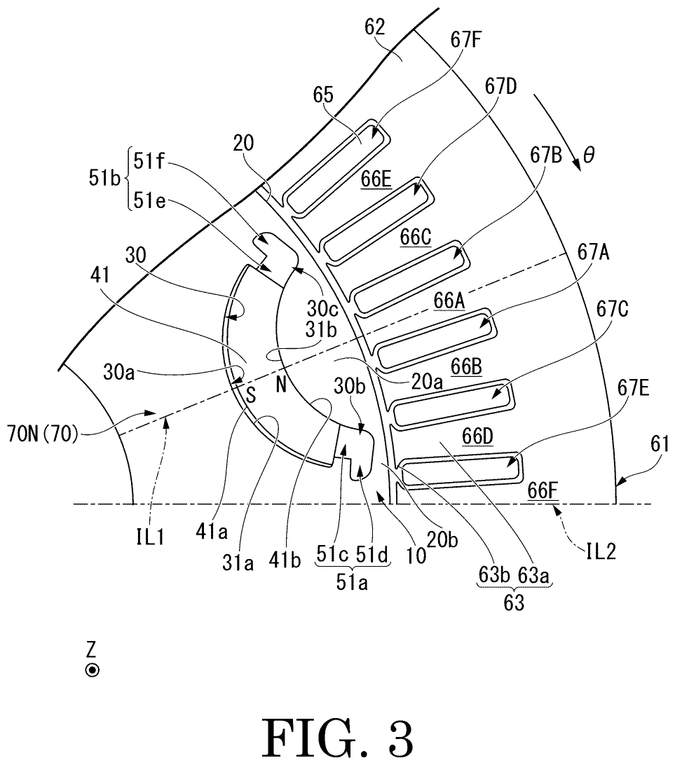

A plurality of the teeth 63 extend to the inner side in the radial direction from the core back 62. The teeth 63 are arranged to be spaced apart from one another in the circumferential direction. For example, a plurality of the teeth 63 are arranged at equal intervals over the entire circumference along the circumferential direction. For example, 48 of the teeth 63 are provided. That is, the number of slots of the rotary electric machine 1 is, for example, 48. As illustrated in FIG. 3, a plurality of teeth 63 include a base portion 63a and an umbrella portion 63b.

The base portion 63a extends to the inner side in the radial direction from the core back 62. The dimension in the circumferential direction of the base portion 63a is, for example, the same over the entire radial direction. Note that the dimension in the circumferential direction of the base portion 63a may decrease, for example, toward the inner side in the radial direction.

The umbrella portion 63b is provided at an end portion on the inner side in the radial direction of the base portion 63a. The umbrella portion 63b protrudes to both sides in the circumferential direction further than the base portion 63a. The dimension in the circumferential direction of the umbrella portion 63b is larger than the dimension in the circumferential direction at an end portion on the inner side in the radial direction of the base portion 63a. A surface on the inner side in the radial direction of the umbrella portion 63b is a curved surface along the circumferential direction. The surface on the inner side of the umbrella portion 63b extends in an arc shape around the center axis J when viewed in the axial direction. The surface on the inner side of the umbrella portion 63b faces an outer peripheral surface of the rotor core 20 described later with a gap interposed between them in the radial direction. The umbrella portions 63b of the teeth 63 adjacent to each other in the circumferential direction are arranged side by side with a gap interposed between them in the circumferential direction.

A plurality of the coils 65 are attached to the stator core 61. As illustrated in FIG. 1, a plurality of the coils 65 are attached to the teeth 63 through the insulator 64. In the present embodiment, distributed winding is used for the coil 65. That is, each of the coils 65 is wound across a plurality of the teeth 63. In the present embodiment, full-pitch winding is used for the coil 65. That is, a circumferential pitch between slots of the stator 60 into which the coil 65 is inserted is equal to a circumferential pitch of magnetic poles generated when three-phase AC power is supplied to the stator 60. The number of poles of the rotary electric machine 1 is, for example, eight. That is, the rotary electric machine 1 is, for example, an 8-pole 48-slot rotary electric machine. As described above, in the rotary electric machine 1 according to the present embodiment, when the number of poles is N, the number of slots is N×6. Note that, in FIGS. 2 and 3, the insulator 64 is not illustrated.

The rotor 10 is rotatable around the center axis J. As illustrated in FIG. 2, the rotor 10 includes a shaft 11, the rotor core 20, and a plurality of magnets 41. The shaft 11 has a columnar shape that extends in the axial direction around the center axis J. As illustrated in FIG. 1, the shaft 11 is rotatably supported around the center axis J by the bearings 5a and 5b.

The rotor core 20 is a magnetic body. The rotor core 20 is fixed to an outer peripheral surface of the shaft 11. The rotor core 20 has a through hole 21 that penetrates the rotor core 20 in the axial direction. As illustrated in FIG. 2, the through hole 21 has a circular shape around the center axis J as viewed in the axial direction.

The shaft 11 passes through the through hole 21. The shaft 11 is fixed inside the through hole 21 by press fitting, for example. Although not illustrated, the rotor core 20 is configured by, for example, a plurality of electromagnetic steel plates stacked in the axial direction.

The rotor core 20 has a plurality of accommodation holes 30. For example, a plurality of the accommodation holes 30 penetrate the rotor core 20 in the axial direction. A plurality of the magnets 41 are accommodated inside a plurality of the accommodation holes 30. A method for fixing the magnet 41 in the accommodation hole 30 is not particularly limited.

A type of a plurality of the magnets 41 is not particularly limited. The magnet 41 may be, for example, a neodymium magnet or a ferrite magnet.

In the present embodiment, a plurality of the accommodation holes 30 and a plurality of the magnets 41 are provided at intervals in the circumferential direction. For example, eight of the accommodation holes 30 and eight of the magnets 41 are provided.

The rotor 10 includes a plurality of magnetic pole portions 70 including one each of the accommodation hole 30 and the magnet 41. For example, eight of the magnetic pole portions 70 are provided. For example, a plurality of the magnetic pole portions 70 are arranged at equal intervals over an entire circumference along the circumferential direction. A plurality of the magnetic pole portions 70 include a plurality of magnetic pole portions 70N in which the magnetic pole on an outer peripheral surface of the rotor core 20 is an N pole and a plurality of magnetic pole portions 70S in which the magnetic pole on an outer peripheral surface of the rotor core 20 is an S pole. For example, four of the magnetic pole portions 70N and four of the magnetic pole portions are provided. Four of the magnetic pole portions 70N and four of the magnetic pole portions 70S are alternately arranged along the circumferential direction.

Configurations of the magnetic pole portions 70 are similar to one another except that the magnetic poles on an outer peripheral surface of the rotor core 20 are different and the circumferential positions are different.

As illustrated in FIG. 3, in the magnetic pole portion 70, the accommodation hole 30 is curved in an arc shape protruding to the inner side in the radial direction as viewed in the axial direction. The accommodation hole has, for example, an arc shape having a curvature center on a magnetic pole center line IL1 outside in the radial direction of the accommodation hole 30 when viewed in the axial direction. The magnetic pole center line IL1 is an imaginary line passing through the center of the magnetic pole portion 70 in the circumferential direction and the center axis J and extending in the radial direction. The accommodation holes 30 extend in directions away from each other in the circumferential direction toward the outer side in the radial direction from the inner side in the radial direction when viewed in the axial direction. An end portion on the outer side in the radial direction of the accommodation hole 30 is located at an outer peripheral edge portion of the rotor core 20 in the radial direction. The accommodation hole 30 is, for example, line-symmetric with respect to the magnetic pole center line IL1 when viewed in the axial direction.

The accommodation hole 30 has a curved portion 30a, an outer end portion 30b, and an outer end portion 30c. The curved portion 30a is curved in an arc shape protruding to the inner side in the radial direction when viewed in the axial direction. The curved portion 30a has a C-shape (C type) when viewed in the axial direction. The curved portion 30a has a first curved surface 31a and a second curved surface 31b as viewed in the axial direction. The first curved surface 31a is located on the inner side in the radial direction. The first curved surface 31a is located on the outer side in the radial direction. The center of curvature of the first curved surface 31a is the same as the center of curvature of the second curved surface 31b. A radius of the first curved surface 31a is larger than a radius of the second curved surface 31b.

The outer end portion 30b is connected to an end portion on the outer side in the radial direction of the curved portion 30a. The outer end portion 30b is an end portion located on the first side in the circumferential direction of the accommodation hole 30 among end portions on the outer side in the radial direction of the curved portion 30a. The outer end portion 30c is connected to an end portion on the outer side in the radial direction of the curved portion 30a. The outer end portion 30c is an end portion located on the second side in the circumferential direction of the accommodation hole 30 among end portions on the outer side in the radial direction of the curved portion 30a.

Note that, in the present specification, “a certain object extends in a direction orthogonal to a certain direction” includes not only a case where the certain object extends in a direction strictly orthogonal to the certain direction but also a case where the certain object extends in a direction substantially orthogonal to the certain direction. The “direction substantially orthogonal to a certain direction” includes, for example, a direction inclined within a range of about several degrees [° ] with respect to a direction strictly orthogonal to the certain direction due to tolerance or the like at the time of manufacturing.

The magnet 41 is accommodated in the accommodation hole 30. For example, the magnet 41 is curved in an arc shape protruding to the inner side in the radial direction when viewed in the axial direction. The magnet 41 has a C-shape (C type) when viewed in the axial direction. According to the present embodiment, since only one of the magnets 41 is arranged for each of the magnetic pole portions 70, magnet cost can be reduced.

Although not illustrated, the magnet 41 is provided over the entire accommodation hole 30 in the axial direction, for example. The magnet 41 extends along the accommodation hole 30 when viewed in the axial direction. The magnets 41 extend in directions away from each other in the circumferential direction toward the outer side in the radial direction from the inner side in the radial direction when viewed in the axial direction. That is, a distance in the circumferential direction between the magnets 41 extending to the outer side in the radial direction increases toward the outer side in the radial direction from the inner side in the radial direction.

The magnet 41 is fitted in the accommodation hole 30. More specifically, the magnet 41 is fitted in the curved portion 30a. The magnet 41 has a third curved surface 41a and a fourth curved surface 41b when viewed in the axial direction. The third curved surface 41a of the magnet 41 is located on the inner side in the radial direction. The third curved surface 41a faces the first curved surface 31a of the accommodation hole 30. The fourth curved surface 41b of the magnet 41 is located on the outer side in the radial direction. The fourth curved surface 41b faces the second curved surface 31b of the accommodation hole 30. The second curved surface 31b of the accommodation hole 30 is in close contact with the fourth curved surface 41b of the magnet 41 at a portion closer to the center side in the circumferential direction than at least an end portion in the circumferential direction.

In a case where the second curved surface 31b of the accommodation hole 30 is in close contact with only an end portion of the fourth curved surface 41b of the magnet 41, a load is locally applied to an edge portion of the end portion of the magnet 41 by a centrifugal force accompanying rotation of the rotor core 20, and stress is concentrated. In the present embodiment, since the second curved surface 31b of the accommodation hole 30 is in close contact with the fourth curved surface 41b of the magnet 41 at a portion closer to the center side in the circumferential direction than an end portion in the circumferential direction, the second curved surface 31b of the accommodation hole 30 curved with respect to each other and the fourth curved surface 41b of the magnet 41 are in close contact with each other, so that stress concentration can be alleviated. In addition, as a length of close contact between the second curved surface 31b and the fourth curved surface 41b is large, a load per unit length is reduced, so that stress concentration can be further alleviated. In order to further alleviate stress concentration, the fourth curved surface 41b on the outer side in the radial direction of the magnet 41 is in close contact with the second curved surface 31b on the outer side in the radial direction of the accommodation hole 30 on the entire surface. By bringing the fourth curved surface 41b into close contact with the second curved surface 31b on the entire surface, stress concentration can be further alleviated.

When viewed in the axial direction, both end portions of the magnet 41 are arranged away from both end portions of the accommodation hole 30. When viewed in the axial direction, the outer end portion 30b and the outer end portion 30c are arranged adjacent to each other on both sides of the magnet 41 in a direction in which the magnet 41 extends. Here, in the present embodiment, the outer end portion 30b is a cavity portion 51a constituting a flux barrier portion. The outer end portion 30c is a cavity portion 51b constituting a flux barrier portion. That is, the rotor core 20 has the cavity portions 51a and 51b constituting a pair of flux barrier portions arranged with the magnet 41 interposed between them in a direction in which the magnet 41 extends when viewed in the axial direction.

As described above, the rotor core 20 has flux barrier portions arranged in a pair with the magnet 41 interposed between them in a direction in which the magnet 41 extends when viewed in the axial direction. The flux barrier portion is a portion capable of reducing flow of a magnetic flux. That is, a magnetic flux hardly passes through each flux barrier portions. Each flux barrier portion is not particularly limited as long as the flux barrier portion can reduce flow of a magnetic flux, and the cavity portions 51a and 51b may include a non-magnetic portion such as a resin portion.

In the magnetic pole portion 70N, a magnetic pole located on the outer side in the radial direction among magnetic poles of the magnet 41 is, for example, an N pole. In the magnetic pole portion 70N, a magnetic pole located on the inner side in the radial direction among magnetic poles of the magnet 41 is, for example, an S pole. Although not illustrated, in the magnetic pole portion 70S, a magnetic pole of each of the magnets 41 is inverted with respect to the magnetic pole portion 70N. That is, in the magnetic pole portion 70S, a magnetic pole located on the outer side in the radial direction among magnetic poles of the magnet 41 is, for example, an S pole. In the magnetic pole portion 70S, a magnetic pole located on the inner side in the radial direction among magnetic poles of the magnet 41 is, for example, an N pole.

A pair of the cavity portions 51a and 51b are provided for each of the magnetic pole portions 70. In each of the magnetic pole portions 70, the cavity portions 51a and 51b are, for example, arranged line-symmetrically with respect to the magnetic pole center line IL1 when viewed in the axial direction. Hereinafter, description of the cavity portion 51b may be omitted for a configuration same as the cavity portion 51a except the configuration of line symmetry with respect to the magnetic pole center line IL1.

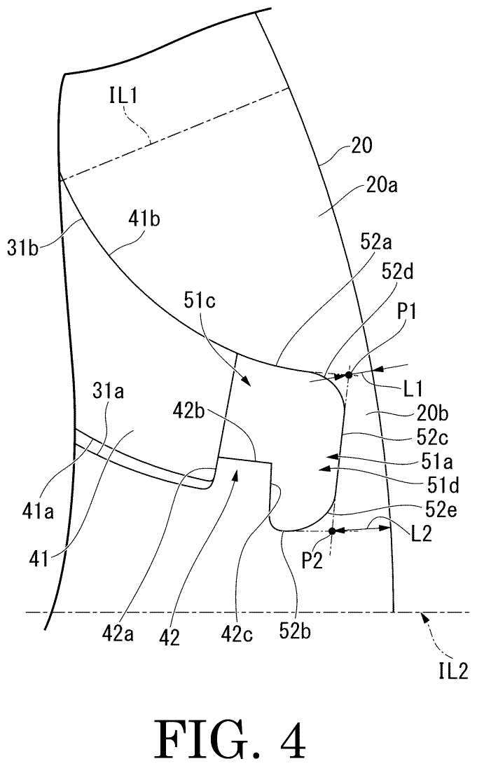

FIG. 4 is an enlarged diagram of a periphery of an end portion on the first side in the circumferential direction of the magnet 41 and the accommodation hole 30.

As illustrated in FIG. 4, the cavity portion 51a has a first portion 51c and a second portion 51d. The first portion 51c extends to the outer side in the radial direction from an end portion on the outer side in the radial direction of the magnet 41. The second portion 51d extends from an end portion on the outer side in the radial direction of the first portion 51c to the first side in the circumferential direction. The second portion 51d extends to the outer side in the circumferential direction with respect to the magnetic pole center line IL1. According to the present embodiment, the accommodation hole 30 and the cavity portions (flux barrier portions) 51a and 51b have an Q shape (Q type) when viewed in the axial direction.

When the second portion 51d constituting a flux barrier portion extends to the center side in the circumferential direction with respect to the magnetic pole center line IL1, there is possibility that reluctance torque is adversely affected and a motor characteristic is lowered. However, since the second portion 51d extends to the outer side in the circumferential direction with respect to the magnetic pole center line IL1, lowering in a motor characteristic can be reduced.

When viewed in the axial direction, an outer shape contour line of the cavity portion 51a has a first contour line 52a, a second contour line 52b, a third contour line 52c, a fourth contour line 52d, and a fifth contour line 52e. The first contour line 52a is located on the center side in the circumferential direction in the outer shape contour line and extends in the radial direction. The first contour line 52a is located on an extension line of the second curved surface 31b located on the first side in the circumferential direction of the second curved surface 31b of the accommodation hole 30. An inner surface of the cavity portion 51a constituting the first contour line 52a is flush with the second curved surface 31b. The second contour line 52b is located further on the outer side in the circumferential direction than the first contour line 52a and extends in the radial direction. The third contour line 52c is located on the outer side in the radial direction between the first contour line 52a and the second contour line 52b in the circumferential direction and extends in the circumferential direction. The fourth contour line 52d has an arc shape connecting the first contour line 52a and the third contour line 52c. The fourth contour line 52d constitutes a round chamfered portion between the first contour line 52a and the third contour line 52c. The fifth contour line 52e has an arc shape connecting the second contour line 52b and the third contour line 52c. The fourth contour line 52d constitutes a round chamfered portion between the second contour line 52b and the third contour line 52c.

Since the cavity portion 51a is provided with the fourth contour line 52d and the fifth contour line 52e, it is possible to alleviate stress concentration generated at a corner portion of the cavity portion 51a. Since the first contour line 52a, the second contour line 52b, the third contour line 52c, the fourth contour line 52d, and the fifth contour line 52e constituting an outer shape contour line of the cavity portion 51a are located in a manner flush with the second curved surface 31b on the outer side in the radial direction of the accommodation hole 30 or further on the outer side in the circumferential direction than the second curved surface 31b, lowering in a motor characteristic can be reduced.

The second portion 51d located on the outer side in the radial direction of the cavity portion 51a gradually increases in distance from an outer peripheral surface of the rotor core 20 toward the outer side in the circumferential direction. More specifically, an intersection between the first contour line 52a and the third contour line 52c located on the center side in the circumferential direction in the second portion 51d is defined as P1, and a distance between the intersection P1 and an outer peripheral surface of the rotor core 20 is defined as L1. An intersection between the second contour line 52b and the third contour line 52c located on the outer side in the circumferential direction in the second portion 51d is defined as P2, and a distance between the intersection P2 and an outer peripheral surface of the rotor core 20 is defined as L2. The distance L2 is larger than the distance L1. As an example, the distance L1 is preferably 1 mm or more. The distance L2 is preferably larger than the distance L1, for example, 2.5 mm or more.

A force to the outer side in the radial direction is applied to the magnet 41 by a centrifugal force during rotation of the rotor 10. This force is applied via the fourth curved surface 41b on the outer side in the radial direction of the magnet 41 to a region 20a located further on the center side in the circumferential direction (outer side in the radial direction) than the fourth curved surface 41b illustrated in FIGS. 3 and 4 in the rotor core 20. The region 20a is connected to a portion on the outer side in the circumferential direction of the rotor core 20 in a narrow region 20b between the second portion 51d and an outer peripheral surface of the rotor core 20. For this reason, in a case where a length in the circumferential direction of the second portion 51d is the same as a length in the circumferential direction of the first portion 51c and is short, a force from the magnet 41 due to a centrifugal force needs to be borne by the region 20b where a length in the circumferential direction is short, and stress in the region 20b becomes large.

According to the present embodiment, the second portion 51d extends further to the outer side in the radial direction than the first portion 51c, and a length in the circumferential direction of the second portion 51d is longer than a length in the circumferential direction of the first portion 51c. For this reason, a force from the magnet 41 due to a centrifugal force can be borne by the region 20b having a large length in the circumferential direction, and stress in the region 20b can be reduced. According to the present embodiment, a load on the rotor core 20 can be reduced by reducing stress in the region 20b.

According to the present embodiment, since the distance L2 between the intersection P2 located on the outer side in the circumferential direction in the second portion 51d and an outer peripheral surface of the rotor core 20 is larger than the distance L1 between the intersection P1 located on the center side in the circumferential direction and an outer peripheral surface of the rotor core 20, a force from the magnet 41 due to a centrifugal force can be borne by the region 20b gradually widened toward the outer side in the circumferential direction, and stress in the region 20b can be further reduced.

The rotor core 20 has a protruding wall 42 protruding into the cavity portion 51a. The protruding wall 42 protrudes from the first curved surface 31a on the inner side in the radial direction of the accommodation hole 30 into the cavity portion 51a at a position further on the outer side in the radial direction than an end portion on the outer side in the radial direction of the magnet 41 when viewed in the axial direction. The protruding wall 42 has a first surface 42a, a second surface 42b, and a third surface 42c. The first surface 42a extends from the first curved surface 31a on the inner side in the radial direction of the accommodation hole 30 when viewed in the axial direction to the cavity portion 51a along a normal direction of a tangent of the first curved surface 31a. The first surface 42a faces and in contact with an end portion on the outer side in the radial direction of the magnet 41. The second surface 42b extends to the outer side in the radial direction from a tip of the first surface 42a. The third surface 42c extends to the outer side in the circumferential direction from an end portion on the outer side in the radial direction of the second surface 42b. The third surface 42c is inclined in a direction away from the first surface 42a toward the outer side in the circumferential direction.

As an example, a length of the first surface 42a protruding into the cavity portion 51a and being in contact with an end surface on the outer side in the radial direction of the magnet 41 is preferably ⅓ or more of a length of an end surface of the magnet 41. The angle at which the third surface 42c is inclined with respect to the first surface 42a is preferably, for example, 10° or more. As an example, a length of the second surface 42b is preferably ¼ or more of a length of an end surface of the magnet 41.

In the rotor core 20, unlike the region 20a to which a centrifugal force is applied via the magnet 41 and the narrow region 20b that is located between the second portion 51d and an outer peripheral surface of the rotor core 20 and supports the region 20a, the protruding wall 42 protrudes from the first curved surface 31a on the inner side in the radial direction of the accommodation hole 30 into the cavity portion 51a. The first surface 42a of the protruding wall 42 is in contact with an end surface of the magnet 41. Therefore, according to the present embodiment, a part of the centrifugal force applied via the magnet 41 is supported and borne by the protruding wall 42 having sufficient strength from the outer side in the radial direction. For this reason, a load and stress on the region 20b due to a centrifugal force applied via the magnet 41 are reduced. According to the present embodiment, a load on the rotor core 20 can be reduced by reducing stress in the region 20b.

According to the present embodiment, the third surface 42c is inclined in a direction away from the first surface 42a toward the outer side in the circumferential direction. For this reason, a width of a proximal end is larger than a width of a distal end of the protruding wall 42, and bending strength against a centrifugal force applied via the magnet 41 can be made large as compared with a case where the third surface 42c is parallel to the first surface 42a without being inclined.

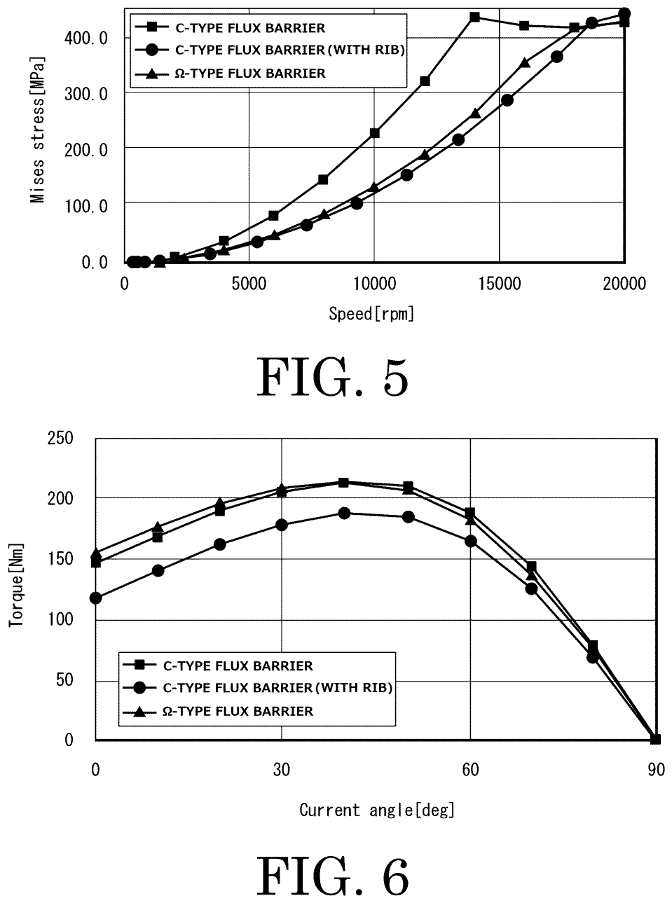

FIG. 5 is a diagram illustrating a relationship between a rotational speed of the rotor 10 and von Mises stress. FIG. 5 illustrates a relationship between a rotational speed of the rotor 10 and von Mises stress for each of motors including the conventional C-type flux barrier portion, the conventional C-type flux barrier portion having a rotor core provided with a rib, and an Q-type flux barrier portion shown in the present embodiment. As illustrated in FIG. 5, in a case where the rotational speed is about 18000 (rpm) or less, von Mises stress is large in the motor having the C-type flux barrier portion, and von Mises stress is small and strength of the rotor core is large in the motor having the C-type flux barrier portion provided with a rib and the motor having the Q-type flux barrier portion.

FIG. 6 is a diagram illustrating a relationship between a current lead angle and torque.

FIG. 6 illustrates a relationship between a current lead angle and torque for each of motors having a C-type flux barrier portion, a C-type flux barrier portion provided with a rib, and an Q-type flux barrier portion. As illustrated in FIG. 6, the motor having a C-type flux barrier portion provided with a rib has low torque, and the motor having a C-type flux barrier portion and the motor having an Q-type flux barrier portion can obtain high torque.

As illustrated in FIGS. 5 and 6, in the motor having an Q-type flux barrier portion of the present embodiment, since von Mises stress is small, strength of the rotor core is large, and high torque is obtained.

In a certain state in which the center in the circumferential direction of the magnet 41 is arranged at the same circumferential position as the center in the circumferential direction of a certain one of the teeth 63 (hereinafter simply referred to as “certain state”), the tooth 63 in which the center in the circumferential direction is arranged at the same circumferential position as the center in the circumferential direction of the magnet 41 is referred to as a tooth 66A. FIGS. 2 to 4 illustrate an example of the certain state. That is, in the certain state illustrated in FIGS. 2 to 4, the tooth 66A corresponds to “certain one of the teeth”. In the certain state illustrated in FIGS. 2 to 4, the magnetic pole center line IL1 passes through the center in the circumferential direction of the tooth 66A when viewed in the axial direction. Further, in the present specification, the “certain state” is a state in which “the center position in the circumferential direction of the tooth 66A coincides with the magnetic pole center line IL1 that is a d axis”.

In the certain state illustrated in FIGS. 2 to 4, the tooth 63 adjacent to the first side in the circumferential direction (+θ side) of the tooth 66A is referred to as a tooth 66B. The tooth 63 adjacent to the second side in the circumferential direction (−θ side) of the tooth 66A is referred to as a tooth 66C. The tooth 63 adjacent to the first side in the circumferential direction of the tooth 66B is referred to as a tooth 66D. The tooth 63 adjacent to the second side in the circumferential direction of the tooth 66C is referred to as a tooth 66E.

As illustrated in FIG. 3, in the certain state, an end portion on the center side in the circumferential direction of the cavity portion 51a is located on the inner side in the radial direction of the tooth 66D. An end portion on the center side in the circumferential direction of the cavity portion 51b is located on the inner side in the radial direction of the tooth 66E. That is, in the certain state, the teeth 66D and 66E correspond to “another tooth”. In this case, each of the teeth 66D and 66E is a tooth that is two teeth away from the tooth 66A corresponding to “certain one of the teeth” in the circumferential direction. That is, in the present embodiment, each of the teeth 66D and 66E which is “another tooth” is the tooth 63 arranged two teeth away from “certain one of the teeth” in the circumferential direction.

In the present embodiment, in the certain state, when viewed in the axial direction, an end portion on the outer side in the circumferential direction of the cavity portion 51a is located on the inner side in the radial direction of a slot 67E. In the certain state, an end portion on the outer side in the circumferential direction of the cavity portion 51a overlaps the slot 67E in the radial direction when viewed in the axial direction. In the certain state, when viewed in the axial direction, an end portion on the outer side in the circumferential direction of the cavity portion 51a is located further on the outer side in the circumferential direction than an end portion on the first side in the circumferential direction (+θ side) of the umbrella portion 63b of the tooth 66D. In the certain state, when viewed in the axial direction, an end portion on the outer side in the circumferential direction of the cavity portion 51a is located further on the center side in the circumferential direction than the center in the circumferential direction of the slot 67E.

In the present embodiment, in the certain state, when viewed in the axial direction, an end portion on the outer side in the circumferential direction of the cavity portion 51b is located on the inner side in the radial direction of a slot 67F. In the certain state, an end portion on the outer side in the circumferential direction of the cavity portion 51b overlaps the slot 67F in the radial direction when viewed in the axial direction. In the certain state, when viewed in the axial direction, an end portion on the outer side in the circumferential direction of the cavity portion 51b is located further on the outer side in the circumferential direction than an end portion on the second side in the circumferential direction (−θ side) of the umbrella portion 63b of the tooth 66E. In the certain state, when viewed in the axial direction, an end portion on the outer side in the circumferential direction of the cavity portion 51b is located further on the center side in the circumferential direction than the center in the circumferential direction of the slot 67F.

According to the present embodiment, by setting positions of end portions on the outer side in the circumferential direction of the cavity portions 51a and 51b within the above range, a distance between the cavity portion 51a and the cavity portion 51b is shortened between adjacent ones of the magnetic pole portions 70, and it is possible to prevent lowering in strength of the rotor core 20.

While the preferred embodiment of the present invention is described above with reference to the accompanying drawings, it is obvious that the present invention is not limited to the embodiment. Various shapes, combinations, and the like of the constituent members in the above embodiment are only by way of example, and various modifications are possible based on design requirements and the like without departing from the gist of the present invention.

A rotary electric machine to which the present invention is applied is not limited to a motor, and may be a generator. In this case, the rotary electric machine may be a three-phase AC generator. Application of the rotary electric machine is not particularly limited. For example, the rotary electric machine may be mounted on a vehicle or may be mounted on equipment other than a vehicle. The number of poles and the number of slots of the rotary electric machine are not particularly limited. In the rotary electric machine, a coil may be configured by any winding method. The configurations described above in the present description may be appropriately combined in a range where no conflict arises.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotary electric machine comprising:
a rotor rotatable around a center axis; and
a stator located on an outer side in a radial direction of the rotor, wherein
the rotor includes:
a rotor core having an accommodation hole; and
a magnet accommodated inside the accommodation hole,
the stator includes:
a stator core having an annular core back surrounding the rotor core and a plurality of teeth extending from the core back to an inner side in a radial direction and arranged side by side at intervals in a circumferential direction; and
a plurality of coils attached to the stator core,
the accommodation hole
is curved in an arc shape protruding to an inner side in the radial direction when viewed in an axial direction, and
has a first curved surface located on an inner side in the radial direction and a second curved surface located on an outer side in the radial direction,
the magnet
is provided in the accommodation hole and is curved in an arc shape extending along the accommodation hole as viewed in the axial direction, and
has a third curved surface located on an inner side in the radial direction and a fourth curved surface located on an outer side in the radial direction,
the rotor core has a pair of cavity portions arranged with the magnet interposed therebetween when viewed in the axial direction,
the second curved surface is in close contact with the fourth curved surface at a portion closer to a center side in the circumferential direction than at least an end potion in the circumferential direction, and
at least a part of the cavity portion extends to an outer side in the circumferential direction with respect to a center of a pole.

2. The rotary electric machine according to claim 1, wherein when viewed in the axial direction, an outer shape contour line of the cavity portion is flush with the second curved surface or located further on the outer side in the circumferential direction than the curved surface.

3. The rotary electric machine according to claim 2, wherein the outer shape contour line includes:
a first contour line located on a center side in the circumferential direction and extending in the radial direction;
a second contour line located further on the outer side in the circumferential direction than the first contour line and extending in the radial direction;
a third contour line located on an outer side in the radial direction between the first contour line and the second contour line in the circumferential direction and extending in the circumferential direction;
a fourth contour line having an arc shape connecting the first contour line and the third contour line; and
a fifth contour line having an arc shape connecting the second contour line and the third contour line.

4. The rotary electric machine according to claim 1, wherein
the cavity portion includes:
a first portion extending to an outer side in the radial direction from an end portion on an outer side in the radial direction of the magnet; and
a second portion extending to an outer side in the circumferential direction from an end portion on an outer side in the radial direction of the first portion, and
the second portion has a larger distance from an outer peripheral surface of the rotor core toward an outer side in the circumferential direction.

5. The rotary electric machine according to claim 1, wherein
the rotor core has a protruding wall that protrudes from the first curved surface into the cavity portion at a position further on an outer side in the radial direction than an end portion on an outer side in the radial direction of the magnet when viewed in the axial direction,
the protruding wall includes:
a first surface that extends to an inner side in the circumferential direction from the first curved surface toward the cavity portion along a normal direction of a tangent of the first curved surface when viewed in the axial direction and faces an end portion on an outer side in the radial direction of the magnet;
a second surface extending to an outer side in the radial direction from a distal end of the first surface; and
a third surface extending to an outer side in the circumferential direction from an end portion on an outer side in the radial direction of the second surface, and
the third surface is inclined in a direction away from the first surface toward an outer side in the circumferential direction.

6. The rotary electric machine according to claim 1, wherein the fourth curved surface is in close contact with the second curved surface on an entire surface.

7. The rotary electric machine according to claim 1, wherein the cavity portion is a flux barrier portion.
